(19) United States
(12) Patent Application Publication
(10) Pub. No.: US 2006/0251280 A1
(43) Pub. Date: Nov. 9, 2006

(54) Retainable hearing aid and method thereof

(76) Inventors: William H. Fennell, Dublin, GA (US); Lavonne Ennis, Talbotton, GA (US)

Correspondence Address: WILLIAMSON INTELLECTUAL PROPERTY LAW, LLC, 1870 THE EXCHANGE, SUITE 100, ATLANTA, GA, 30339, US

(21) Appl. No.: 11/121,607

(22) Filed: May 4, 2005

(51) Int. Cl. H04R 25/00

(52) U.S. Cl. 381/328

(57) ABSTRACT

A retainable hearing aid and method thereof, wherein an anchor point defined in the hearing aid facilitates attachment to a fastener that is attached to a linear member, wherein the linear member selectively secures a pair of hearing aids together and/or retains a single hearing aid. Additionally, the linear member may be removably attached to a necklace portion that is worn about the neck of a person, thereby preventing accidental hearing aid loss.

### TECHNICAL FIELD

The present invention relates generally to hearing aids, and more specifically to a retainable hearing aid and method thereof, wherein the hearing aid is retained and prevented from falling when removed from the ear, whether said removal is deliberate or inadvertent.

### BACKGROUND OF THE INVENTION

Hearing aids may be provided to a wearer in need thereof either individually or as a pair. Some hearing aids of more recent vintage reside fully within the ear envelope, while other older devices are held behind the ears and have an extension tube for aural communication between the inner ear and the electronic circuitry contained within the hearing aid. Unfortunately, hearing aids can inadvertently fall from the ear and become damaged or lost. Furthermore, oftentimes individuals remove hearing aids during periods when they are not required, whereafter they may become separated from one another and/or misplaced.

Various hearing aid supports are found, wherein the hearing aid is contained within a structure. One such device comprises a ring and frame, wherein the device utilizes the ear or head to support a hearing aid contained within the ring structure. Similar to such supports are straps or bands that secure an external hearing aid by containing the hearing aid within portions of the strap, and head bands that contain the body of a hearing aid within slits in the head band. Another device utilizes an eyeglass frame with support extensions attached to the legs of the eyeglass frame, wherein the support extensions accommodate hearing aids within an enclosure.

Although such devices adequately contain a hearing aid and maintain it in position, they are bulky because they function by containing the hearing aid rather than attaching to a portion thereof. Further, such devices may inadvertently release the hearing aid, and as such, do not provide security from loss, separation, misplacement or the like.

Therefore, it is readily apparent that there is a need for a retainable hearing aid and method thereof, wherein the hearing aid has a removable fastener incorporated therein, whereby a cord can communicate with the removable fastener, and thereby retain a hearing aid about the neck of the wearer and/or retain a pair of hearing aids together.

### BRIEF SUMMARY OF THE INVENTION

Briefly described, in a preferred embodiment, the present invention overcomes the above-mentioned disadvantages and meets the recognized need for such a device by providing a retainable hearing aid and method thereof, wherein an attachment point is defined on the hearing aid for securing a cord between two hearing aids, or alternately, to enable retention of a single hearing aid. The cord has a fastener at approximately the midpoint thereof, wherein the fastener facilitates removable attachment to a necklace, while same is worn around the neck of the hearing aid wearer.

The cord functions to retain the pair of hearing aids together in a connected relationship, wherein the attachment of the cord to the necklace further secures the combination of cord and hearing aids to the wearer. The cord prevents loss or damage to the hearing aids in the event that one or both are removed from the ear either inadvertently or deliberately. The removed hearing aids are retained in proximity to the wearer's ears so that they can be reinserted as desired. When the hearing aids are no longer required, the cord can be removed from the necklace and placed securely away, while still retaining the hearing aids together for future use.

According to its major aspects and broadly stated, the present invention in its preferred form is a secure hearing aid and method therefor, wherein a hearing aid, or a pair of hearing aids, is retained on a cord or strap that connects to the hearing aids. The cord or strap is further secured via a removable clip to a necklace or other member encircling the wearer's neck.

Securing the hearing aids and cord to a necklace prevents the possibility that while the hearing aids are being worn, they could disengage and fall to the ground, thereby incurring potential damage or loss. Additionally, by tethering the hearing aids together, separation and misplacement or loss thereof is prevented.

More specifically, the present invention is a retainable hearing aid and method thereof, wherein the retainable hearing aid comprises a hearing aid combined with an anchor. The anchor is a wire formed into a ‘U’-shape, wherein the legs of the ‘U’-shape are secured to the hearing aid. In order to avoid potential interference, the anchor wire is preferably of a non-magnetic material, such as, for exemplary purposes only, stainless steel.

The anchor facilitates creation of a linked pair of hearing aids, secured together via a cord or strap that permits the hearing aids to be utilized in their separate ears. The hearing aids remain together, connected by the cord or strap so that they cannot become separated from one another and potentially lost. The cord further has a fastener located at approximately the midpoint of the cord, wherein the fastener can be selectively connected to, or removed from, a necklace worn about the neck of the hearing aid user.

By securing the hearing aids together via the cord, separation of the hearing aids is prevented. With the further attachment of the cord to the necklace, inadvertent removal of a hearing aid from the ear will not result in potential loss or damage, because the hearing aid is prevented from falling to the ground. Because the hearing aid is retained close to the body of the user, it can be readily retrieved and reinserted into the ear. When it is desirable to remove the hearing aids, removal of the cord from the necklace results in retention of the hearing aids together so that they will both be readily available when later use is desired.

Accordingly, a feature and advantage of the present invention is its ability to provide a secure means for retention of hearing aids while being worn.

Another feature and advantage of the present invention is its ability to retain two hearing aids together.

Still another feature and advantage of the present invention is its ability to prevent loss or misplacement of hearing aids.

Yet another feature and advantage of the present invention is its ability to permit secure retention of hearing aids together when not in use.

Yet still another feature and advantage of the present invention is that it can be installed to secure existing hearing aids.

A further feature and advantage of the present invention that it keeps hearing aids close and ready when not in use.

Yet a further feature and advantage of the present invention is its ability to prevent damage to hearing aids.

Yet still a further feature and advantage of the present invention is that it is decorative to the wearer.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1 is a perspective view of a retainable hearing aid according to a preferred embodiment of the present invention, showing a hearing aid with an anchor;

FIG. 2 is perspective view of a hearing aid retention, according to a preferred embodiment of the present invention;

FIG. 3 is perspective view of the hearing aid retention device of FIG. 2, according to a preferred embodiment of the present invention, showing the device in use; and

FIG. 4 is a perspective view of a retainable hearing aid according to an alternate embodiment of the present invention, showing a hearing aid with an anchor removed.

### DETAILED DESCRIPTION OF THE PREFERRED AND SELECTED ALTERNATIVE EMBODIMENTS

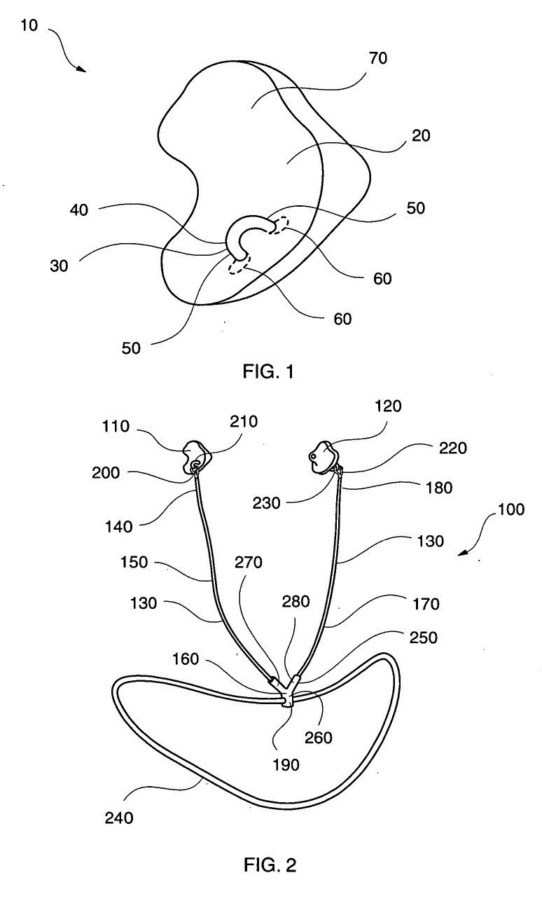

In describing the preferred and selected alternate embodiments of the present invention, as illustrated in FIGS. 1-4, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-3, the present invention in a preferred embodiment is retainable hearing aid 10 preferably comprising hearing aid 20 and anchor 30. Anchor 30 preferably has a ‘U’-shape and is preferably defined by loop 40, legs 50 and extensions 60, wherein loop 40 is preferably formed from stainless steel wire or other non-ferromagnetic material. A non-ferromagnetic material is selected to avoid interference with electronic circuitry and or radio frequency communications within hearing aid 20. It will be recognized by those in the art that other non-ferromagnetic materials, such as, for exemplary purposes only, plastic, and/or ferromagnetic materials could be utilized so long as same did not interfere with the operation of hearing aid 20.

Legs 50 and extensions 60 are preferably installed within body 70 of hearing aid 20 during the process of molding hearing aid 20, thereby preferably securing anchor 30 therewithin. Extensions 60 are preferably disposed at an angle to legs 50, wherein extensions 60 preferably facilitate anchoring of legs 50 within body 70 of hearing aid 20. It will be recognized by those skilled in the art that anchor 30 could be formed from the same material as body 70 of hearing aid 20, wherein anchor 30 is formed during the molding process of hearing aid 20. Further, anchor 30 could be attached to hearing aid 20 in a retrofit method, wherein any suitable securing means, such as, for example, adhesives, are utilized.

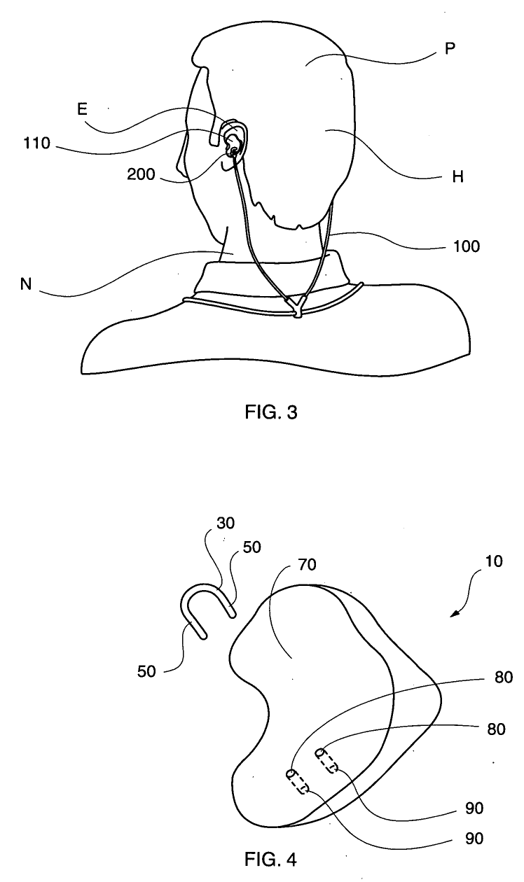

Referring now to FIG. 3, left hearing aid 110 and right hearing aid 120 are preferably typically disposed within ears E of person P. Retainer 100 is preferably defined by securing strap 130, wherein securing strap 130 preferably comprises first end 140, first section 150, middle 160, second section 170, second end 180 and joiner 190, as best shown in FIG. 2. Clip 200 is preferably disposed at first end 140 of first section 150, wherein clip 200 preferably engages anchor 210 of left hearing aid 110. Clip 220 is preferably disposed at second end 180 of second section 170, wherein clip 220 preferably engages anchor 230 of right hearing aid 120. It will be recognized by those skilled in the art that first section 150 and second section 170 could be permanently affixed to anchors 210 and 230, respectively. It will be further recognized by those skilled in the art that first section 150 and second section 170 could alternately comprise separate individual members, together defining securing strap 130.

Hearing aids 110, 120 are preferably retained securely together and upon person P via necklace 240, joiner 190 securing strap 130 and clips 200, 220, thereby defining retainer 100. It will be recognized by those skilled in the art that a single hearing aid 110 could be secured to necklace 240 via securing strap 130, wherein joiner 190 is not required, and wherein one of clips 200, 220 could be secured to hearing aid 110 and the other of clips 200, 220 could be secured to necklace 240.

Joiner 190 is preferably ‘Y’-shaped member 250 preferably defined by first end 260, second end 270 and third end 280, wherein first end 260 is preferably attached to necklace 240. Second end 270 and third end 280 are preferably retained proximate middle 160. It will be recognized by those skilled in the art that although ‘Y’-shaped member 250 is preferred for joiner 190, other shapes could alternately be utilized, and/or other fasteners, such as, for exemplary purposes only, a clip could be utilized.

In use, hearing aids 110, 120 are preferably secured to clips 200, 210 respectively, and retainer 100 is preferably positioned behind head H of person P, wherein first section 150 and second section 170 of securing strap 130 preferably extend from the ears to the area generally behind neck N of person P. Subsequently, joiner 190 is preferably selectively secured to necklace 240. It will be recognized by those skilled in the art that first section 150 and second section 170 could alternatively be positioned in front of neck N, if desired. It is this unique connectability that offers improvements over previous devices, such as remote microphones worn about the neck for transmission of radio frequency signals to hearing aids, and devices for securing eyeglasses about a wearer's head and/or neck, which lacked a means for securing a hearing aid or hearing aid pair.

Referring now more specifically to FIG. 4, illustrated therein is an alternate embodiment of device 10, wherein the alternate embodiment of FIG. 4 is substantially equivalent in form and function to that of the preferred embodiment detailed and illustrated in FIG. 1 except as hereinafter specifically referenced. Specifically, the embodiment of FIG. 4 comprises hearing aid 20, wherein shafts 90 are formed in hearing aid 20, and are adapted to receive legs 50 of anchor 30 via apertures 80. Legs 50 could be inserted through apertures 80 into shafts 90 and secured therewithin via a suitable adhesive. Alternately, legs 50 could be resiliently held or slidably locked therewithin.

In an alternate embodiment of the present invention, the anchor may be integrally-molded of the same, or different, material from the body of the hearing aid. In another alternate embodiment of the present invention, the wire loop can be installed into an existing hearing aid by forming holes therein, into which the legs of the wire loop can be subsequently inserted and secured via adhesive, or the like. In yet another alternate embodiment of the present invention, it is envisioned that anchor 30 could comprise any shape suitable for attachment of a fastener thereto, such as, for exemplary purposes only, a rectangular opening, other angular opening or circular opening.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A retainable hearing aid comprising:
a hearing aid; and
a loop, said loop securely extending from said hearing aid, said loop adapted to receive a first means for attachment.

2. The retainable hearing aid of claim 1, wherein said loop is integral to said hearing aid.

3. The retainable hearing aid of claim 1, wherein said loop comprises a wire.

4. The retainable hearing aid of claim 3, wherein said wire comprises a “U” shape.

5. The retainable hearing aid of claim 1, wherein said hearing aid comprises a plurality of shafts, wherein said loop comprises leg extensions, and wherein said leg extensions anchor into said shafts of said hearing aid.

6. The retainable hearing aid of claim 1, wherein said loop is inserted into pre-formed apertures in said hearing aid.

7. The retainable hearing aid of claim 1, wherein said first means for attachment comprises a linear member, having a fastener at each end thereof.

8. The retainable hearing aid of claim 7, wherein said linear member further comprises second means for attachment.

9. The retainable hearing aid of claim 7, wherein said first means for attachment comprises a removable clip.

10. The retainable hearing aid of claim 8, wherein said second means for attachment is fixably secured to a necklace.

11. The retainable hearing aid of claim 8, wherein said second means for attachment is configured to facilitate fixed adaptation to a necklace.

12. The retainable hearing aid of claim 8, wherein said second means for attachment comprises a ‘Y’-shaped member.

13. A method of securing a hearing aid, said method comprising the steps of:
a. obtaining at least one hearing aid, wherein said at least one hearing aid comprises a fixably-attached loop; and
b. utilizing said loop to secure said at least one hearing aid to a cord.

14. The method of claim 13, further comprising the step of:
securing said cord to a necklace.

15. The method of claim 13, wherein said loop comprises a flexible member, and wherein said means for clipping comprises at least one fastener attached to said flexible member.

16. The method of claim 15, further comprising the step of:
attaching said flexible member to a necklace.

17. The method of claim 15, further comprising the step of:
attaching said flexible member to a necklace via a ‘Y’-shaped member.

18. A securely-worn hearing apparatus comprising:
a necklace;
a first hearing aid, wherein said first hearing aid comprises a first anchor member; and
a securing cord removably attached to said first anchor member.

19. The securely-worn hearing apparatus of claim 18, further comprising:
a second hearing aid, wherein said second hearing aid comprises a second anchor member, and wherein said securing cord is removably attached to said second anchor member.

20. The securely-worn hearing apparatus of claim 18, wherein said securing cord further comprises a “Y”-shaped member, wherein said ‘Y’-shaped member comprises a first end, and wherein said “Y”-shaped member is attached to said necklace via said first end.
